(19) United States
(12) Patent Application Publication
(10) Pub. No.: US 2026/0025709 A1
(43) Pub. Date: Jan. 22, 2026

(54) DISTRIBUTED UNIT (DU) POOLING IN OPEN RADIO ACCESS NETWORK (ORAN) WIRELESS TELECOMMUNICATION NETWORKS

(71) Applicant: DISH Wireless L.L.C., Englewood, CO (US)

(72) Inventor: Manish Uniyal, Parker, CO (US)

(21) Appl. No.: 18/774,258

(22) Filed: Jul. 16, 2024

(51) Int. Cl. H04W 28/086

(52) U.S. Cl. CPC H04W 28/0861

(57) ABSTRACT

Systems and methods for Distributed Unit (DU) pooling in ORAN wireless telecommunication networks are disclosed. The system generates multiple virtualized DU instances (vDUs) within a baseband cloud to form an ORAN vDU pool. Baseband processing resources are dynamically shared among cell sites served by respective vDUs within the pool by reallocating idle processing capacities from vDUs serving underutilized cell sites to vDUs serving cell sites with higher traffic demands. The vDUs share common physical server resources, enabling multiple Radio Access Network (RAN) services to run on shared hardware. The system enables efficient resource utilization, enhanced network scalability, and supports multiple cell sites with varying traffic patterns using shared resources.

### TECHNICAL FIELD

The present disclosure relates to wireless telecommunication networks, and specifically to systems and methods for Distributed Unit (DU) pooling in Open Radio Access Network (ORAN) wireless telecommunication networks.

### BRIEF SUMMARY

In various example embodiments, systems and methods are disclosed for implementing DU pooling in wireless telecommunication networks such as those implementing an ORAN system. An ORAN is a nonproprietary version of the Radio Access Network (RAN) system that allows interoperation between cellular network equipment provided by different vendors. Although many embodiments described herein are implemented within an ORAN architecture, the DU pooling systems and methods described herein may be implemented in and/or applicable to other technologies, such as other technologies implemented in Fifth Generation (5G) wireless networks and future Sixth Generation (6G) wireless networks, etc. The techniques described herein enable dynamic sharing of baseband processing resources among multiple cell sites, improving resource utilization and network performance.

The DU plays a significant role in the disaggregated Radio Access Network (RAN) architecture of 5G networks. The DU serves as an intermediary between the Centralized Unit (CU) and the Radio Unit (RU), handling a variety of tasks that are important for the network's operation. At its core, the DU is responsible for managing the lower layers of the RAN protocol stack, including portions of the physical layer, radio link control, and medium access control layers.

One of the primary functions of the DU is to perform time-sensitive operations that require low latency. This includes tasks such as scheduling, beamforming, and certain aspects of radio resource management. These real-time operations are important for maintaining the responsiveness and efficiency of the network. The DU acts as a communication hub, interfacing with both the RU and the CU. The DU communicates with the RU over the fronthaul interface, typically using protocols like enhanced Common Public Radio Interface (eCPRI), while also interfacing with the CU over the mid-haul interface to handle the exchange of user plane and control plane data.

Resource management is another responsibility of the DU. It oversees the allocation and control of radio resources for its connected RUs, which includes tasks like radio bearer control and mobility management. The DU also processes both uplink and downlink user data, applying encoding, decoding, and modulation schemes to ensure efficient data transmission. Network synchronization is also an important function of the DU, as it plays a significant role in maintaining precise timing across the network. This synchronization is important for the proper functioning of the entire cellular system. In the context of 5G's network slicing capabilities, the DU contributes by managing radio resources for different network slices. This function is important for enabling the network to support a diverse range of services with varying requirements on the same physical infrastructure.

The evolution of mobile networks towards 5G has brought about significant changes in network architecture and functionality. One of the innovations in 5G is the concept of network function virtualization (NFV) and the disaggregation of network elements, particularly in the RAN. The disclosure herein provides a system in which the DU is disaggregated as a “virtualized” or “virtual” Distributed Units (vDU) as a component of the ORAN architecture within 5G.

In traditional mobile networks, baseband processing units were typically co-located with radio units at cell sites. However, the 5G architecture introduces a split between the Centralized Unit (CU), Distributed Unit (DU), and Radio Unit (RU). This split architecture, known as CU-DU-RU, allows for more flexible deployment options and improved resource utilization. The vDUs in the system disclosed herein may be responsible for real-time, lower-layer processing functions of the RAN protocol stack. These functions include parts of the physical layer (PHY), the radio link control (RLC), and the medium access control (MAC) layers.

By virtualizing the DU, creating multiple vDUs and pooling the resources of the vDUs, the system disclosed herein enables these functions to be performed with greater flexibility and efficiency. This virtualization and pooling enable dynamic allocation of processing resources based on network demands. Such pooling enables improved resource utilization across multiple cell sites, enhancing the overall efficiency and adaptability of the 5G network.

In particular, in traditional wireless telecommunication networks, each cell site typically has dedicated baseband processing resources. This approach can lead to inefficient resource utilization, as some cell sites may be underutilized while others experience high traffic demands. Additionally, the lack of resource sharing between cell sites limits the network's ability to adapt to changing traffic patterns and optimize overall performance. One primary challenge is effectively managing and allocating baseband processing resources across multiple cell sites to meet varying traffic demands. Another challenge is implementing a flexible architecture that allows for dynamic resource sharing without compromising network reliability or introducing significant complexity.

In an example embodiment, the system described herein addresses these challenges through the implementation of a ORAN vDU pool in an ORAN. The method involves generating multiple vDUs within a baseband cloud in an ORAN to form a ORAN vDU pool. These vDUs share common physical server resources, enabling multiple Radio Access Network (RAN) services to run on shared hardware in an ORAN.

The ORAN architecture facilitates openness and interoperability of radio access networks through standard interfaces and the use of open-source software. ORAN breaks the traditional vendor lock-in by allowing operators to mix and match hardware and software components from different vendors, leading to more flexible, scalable, and cost-effective network deployments. An important feature of ORAN is the disaggregation of network functions, which separates the RAN into the distinct RU, DU and CU components. This separation allows for greater flexibility in deploying network functions across various hardware platforms and locations.

ORAN defines standard interfaces between the RU, DU, and CU, enabling interoperability between equipment from different vendors. For example, the fronthaul interface (F1) connects the RU to the DU, while the midhaul interface (F2) connects the DU to the CU. ORAN leverages virtualization and cloud technologies to run network functions as virtual network functions (VNFs) on general-purpose hardware. This technique reduces the dependency on proprietary hardware and allows for more efficient resource utilization. Additionally, ORAN introduces the concept of the RAN Intelligent Controller (RIC), which provides a platform for deploying advanced algorithms and machine learning models to optimize RAN performance. The RIC enables dynamic and automated management of RAN resources based on real-time data.

In an example embodiment, the DU pooling systems and methods described herein are integrated into ORAN networks to enhance resource utilization and network performance. In an ORAN setup, DUs are virtualized as vDUs running on general-purpose servers within the baseband cloud. The DU pooling method involves generating a plurality of these vDUs to form an ORAN vDU pool 102. This pool 102 allows for the flexible and dynamic allocation of baseband processing resources across multiple cell sites. An aspect of the DU pooling systems and methods described herein is the dynamic sharing of baseband processing resources among vDUs. In an ORAN network, this capability allows for efficient utilization of processing capacities based on real-time traffic demands. By reallocating idle resources from underutilized vDUs to those serving high-traffic cell sites, the network can improve performance and avoid congestion. The system dynamically shares baseband processing resources among the cell sites served by the vDUs within the pool. This is achieved by reallocating idle processing capacities from vDUs serving underutilized cell sites to vDUs serving cell sites with higher traffic demands. For example, if one cell site experiences a surge in traffic while another has spare capacity, the system can reallocate resources to meet the increased demand without the need for additional hardware.

In an example embodiment, each vDU is configured to support a predetermined maximum number of User Equipment (UEs). The vDUs can dynamically adjust the number of UEs supported per cell site up to this maximum, based on the total number of cell sites supported by the ORAN vDU pool and current traffic demands at each site. This flexibility allows the system to efficiently manage resources across multiple cell sites and adapt to changing network conditions.

The ORAN vDU pooling techniques described herein provide several advantages, including improved resource utilization, enhanced network scalability, lower deployment costs as underutilized cells’ resources can be utilized well by high traffic cells, reduced capital expenditures as pooled resources can be used for sites that need additional configurations, mitigation of load imbalances between cells connected to a vDU, and the ability to support multiple cell sites with varying traffic patterns using shared resources.

### BRIEF DESCRIPTION OF THE DRAWINGS

FIG. 1 is a block diagram of a system for DU pooling in wireless ORAN communication networks, according to one non-limiting embodiment.

FIG. 2 is a block diagram of a system for DU pooling in wireless ORAN communication networks showing shared physical server resources, according to one non-limiting embodiment.

FIG. 2 is a block diagram illustrating elements of an example vehicle traffic monitoring device, according to one non-limiting embodiment.

FIG. 3 is a chart illustrating idle capacity detected of a vDU in the ORAN vDU pool, according to one non-limiting embodiment.

FIG. 4 is a chart illustrating reallocation of the detected idle capacity shown in the chart of FIG. 3 to other vDUs in the ORAN vDU pool with higher traffic, according to one non-limiting embodiment.

FIG. 5 is a flow diagram of an example method in a system for DU pooling in wireless ORAN communication networks, according to one non-limiting embodiment.

FIG. 6 is a flow diagram of an example method in a system for DU pooling in wireless ORAN communication networks for utilizing additional capacity available in the ORAN vDU pool, according to one non-limiting embodiment.

FIG. 7 shows a system diagram that describes an example implementation of a computing system(s) for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

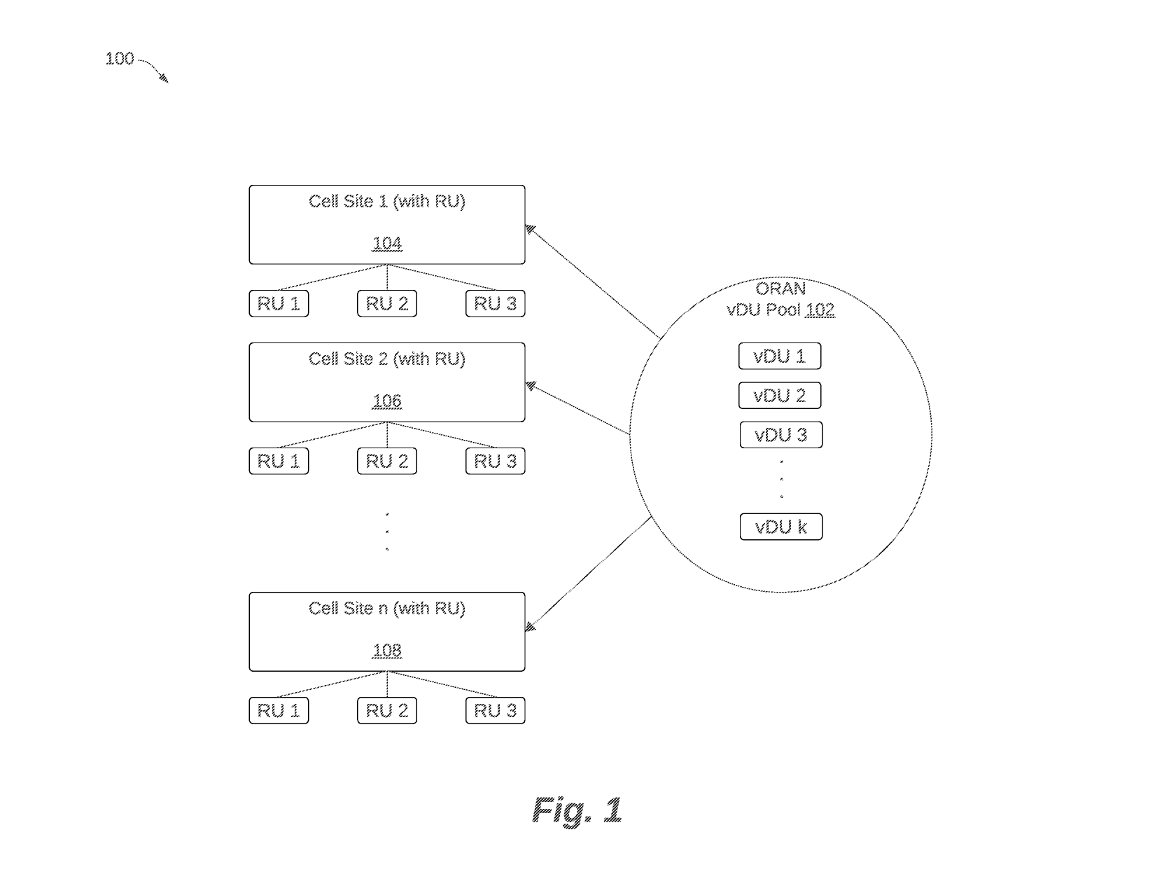

FIG. 1 is a block diagram of a system 100 for DU pooling in wireless ORAN communication networks, according to one non-limiting embodiment.

The system 100 includes a ORAN vDU pool 102 comprising multiple virtualized DU instances (vDUs), including vDU 1, vDU 2, vDU 3…vDU k. Thus, different sizes of ORAN vDU pools may be implemented in various different embodiments. The vDUs shown are generated within a baseband cloud and serve multiple cell sites, such as cell site 1104, cell site 2106, and cell site n 108.

Each cell site includes multiple Radio Units (RUs). Although three RUs per site are shown in the present example, different numbers of RUs may be implemented in various different embodiments. The RUs shown in FIG. 1 are components of the RAN architecture, typically located at the cell site. Each RU’s primary functions may include Radio Frequency (RF) processing, digital-to-analog and analog-to-digital conversion, power amplification, beamforming, fronthaul communication, antenna management, signal filtering, environmental adaptation, network synchronization, and support for multiple radio access technologies, and Massive Multiple-Input Multiple-Output (MIMO) support. Each of the RUs work in close coordination with the corresponding vDU in ORAN vDU pool 102 that is part of the disaggregated 5G RAN architecture. By focusing on RF processing and leaving baseband processing to the vDU, this split architecture allows for more flexible network deployments and enables advanced features like network slicing and edge computing in 5G networks.

The vDUs in system 100 are responsible for real-time, lower-layer processing functions of the 5G Radio Access Network (RAN) protocol stack. These functions include parts of the physical layer (PHY), the radio link control (RLC), and the medium access control (MAC) layers. By virtualizing the DU and pooling the resources of multiple vDUs in ORAN vDU pool 102, the system 100 provides network operators several advantages including flexibility, resource efficiency, network slicing, edge computing and simplified updates and maintenance. The vDUs in ORAN vDU pool 102 may be deployed on commercial off-the-shelf (COTS) hardware, allowing for more cost-effective and scalable solutions. Also, the vDUs in ORAN vDU pool 102 enable dynamic allocation of computing resources based on network demands, leading to better utilization of hardware resources. The vDUs in ORAN vDU pool 102 help to facilitate implementing network slicing, a feature of 5G that allows multiple virtual networks to run on a single physical infrastructure. The vDUs in ORAN vDU pool 102 may also be deployed at the network edge, closer to users, reducing latency and enabling various configurations that require low-latency processing. Software updates and network modifications are also implemented more easily in the virtualized environment provided by ORAN vDU pool 102.

The ORAN vDU pool 102 enables dynamic sharing of baseband processing resources among the cell sites. This is achieved, for example, by reallocating idle processing capacities from vDUs serving underutilized cell sites to vDUs serving cell sites with higher traffic demands. For example, if cell site 1104 experiences a surge in traffic while cell site 2106 has spare capacity, the system 100 can reallocate resources from the vDU serving cell site 2 to the vDU serving cell site 1. In some embodiments, ORAN vDU pool 102 may logically act as a single vDU serving cell site 1104, cell site 2106, and cell site n 108. Examples of functions for which the ORAN vDU pool 102 may provide shared resources include, but not limited to: time-sensitive operations that require low latency, including tasks such as scheduling, beamforming, and certain aspects of radio resource management; fronthaul communications, including communications with the corresponding RU(s) over the fronthaul interface; interfacing with the centralized unit (CU) (not shown) over the midhaul interface to handle the exchange of user plane and control plane data; resource management, including overseeing the allocation and control of radio resources for its connected RUs; radio bearer control and mobility management; processing both uplink and downlink user data, including applying encoding, decoding, and modulation schemes to facilitate ensuing efficient data transmission; network synchronization, including maintaining precise timing across the network; and managing radio resources for different network slices. The ORAN vDU pool 102 of system 100 performs the above functions with greater flexibility and efficiency than traditional systems by enabling dynamic allocation of processing resources based on network demands and providing improved resource utilization across multiple cell sites, enhancing the overall efficiency and adaptability of the 5G network.

In an example embodiment, the standard interfaces defined by ORAN (e.g., F1, F2) facilitate the integration of the DU pooling method described above. These interfaces ensure that the communication between RUs, vDUs, and CUs remains seamless, even when resources are dynamically reallocated within the ORAN vDU pool 102. This interoperability facilitates the effective implementation of the DU pooling strategy. The disaggregated architecture of an ORAN supports scalability and flexibility, which the DU pooling systems and methods described herein leverage by enabling network operators to scale the ORAN vDU pool up or down based on the number of cell sites and the overall traffic demand. This scalability helps to ensure that the network can adapt to changing conditions without significant reconfiguration or downtime.

The RAN Intelligent Controller (RIC) in ORAN may be utilized by providing intelligent control and optimization algorithms. In an example embodiment, the RIC may use real-time data and machine learning models to predict traffic patterns and proactively reallocate resources within the ORAN vDU pool 102, thereby improving the efficiency and responsiveness of the network. By integrating the DU pooling method into an ORAN network, operators may achieve better resource utilization and reduced operational costs. The dynamic sharing of baseband processing resources helps minimize underutilization and ensures that all available resources contribute to maintaining high network performance and quality of service.

In the example shown in FIG. 1, an ORAN-based network includes multiple cell sites, such as cell site 1, cell site 2 and cell site 3, each equipped with RUs connected to the ORAN vDU pool 102 within the baseband cloud. The ORAN vDU pool 102 is managed by the DU pooling method described herein, which continuously monitors traffic demands across all cell sites. During peak hours, certain cell sites may experience high traffic, leading to potential congestion. The DU pooling technique detects this and reallocates idle capacity from underutilized vDUs to those serving the high-traffic cell sites, ensuring smooth and efficient operation.

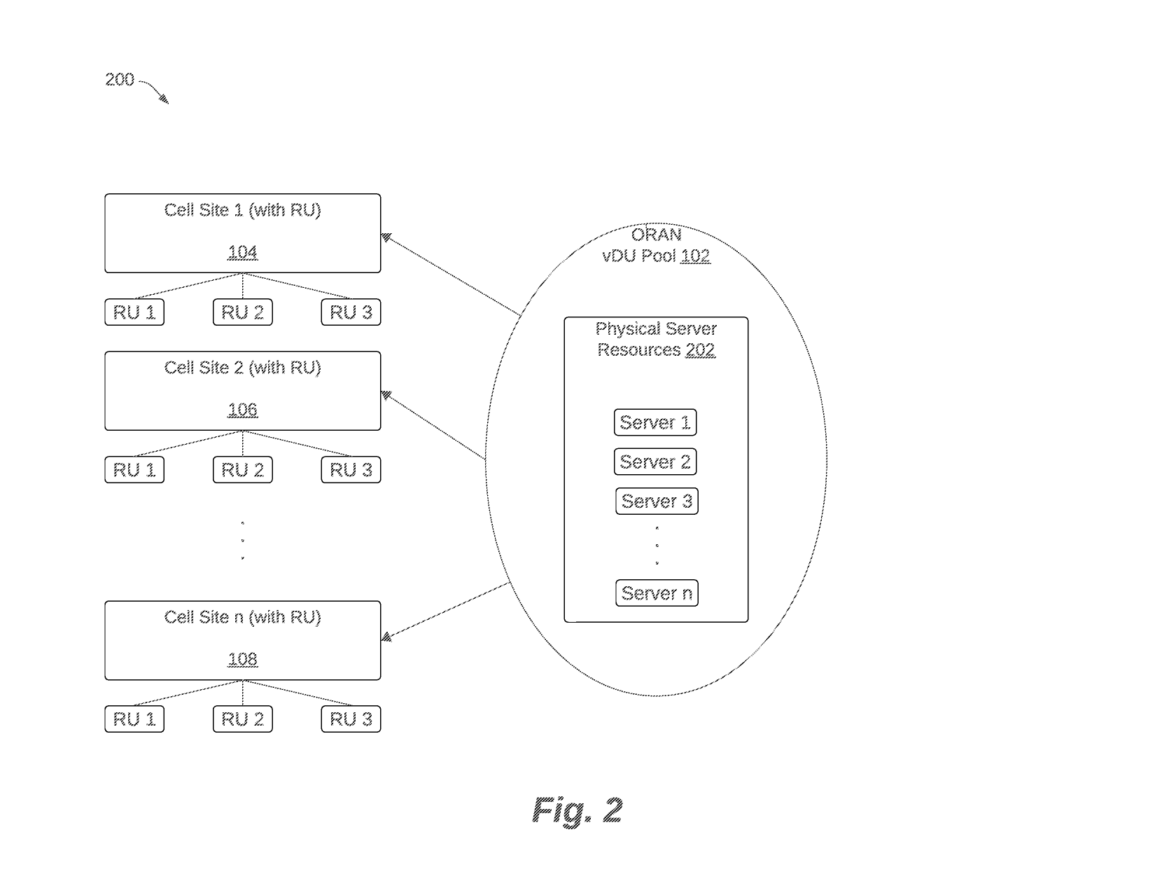

FIG. 2 is a block diagram of a system 200 for DU pooling in wireless ORAN communication networks showing shared physical server resources, according to one non-limiting embodiment.

FIG. 2 illustrates how the ORAN vDU pool 102 of FIG. 1 is supported by physical server resources 202, which may include multiple servers (Server 1, Server 2, Server 3, ..., Server n). These servers provide computing resources to run each of the the vDU instances. With cell site 1104, cell site 2106, and cell site n 108 sharing these common physical server resources, the system enables RAN services provided by the vDUs to run on the shared hardware. Thus, the number of cell sites and the number of servers in system 200 need not be the same and may vary in different embodiments.

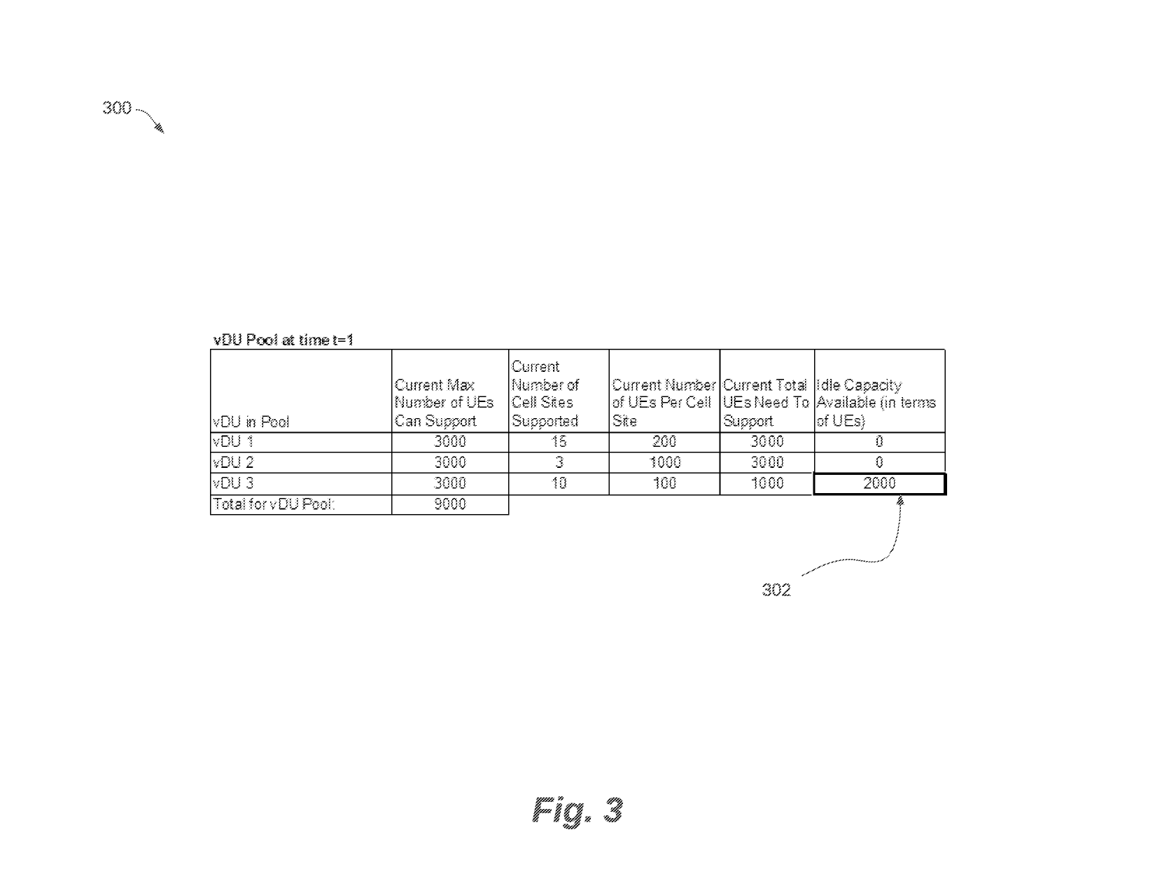

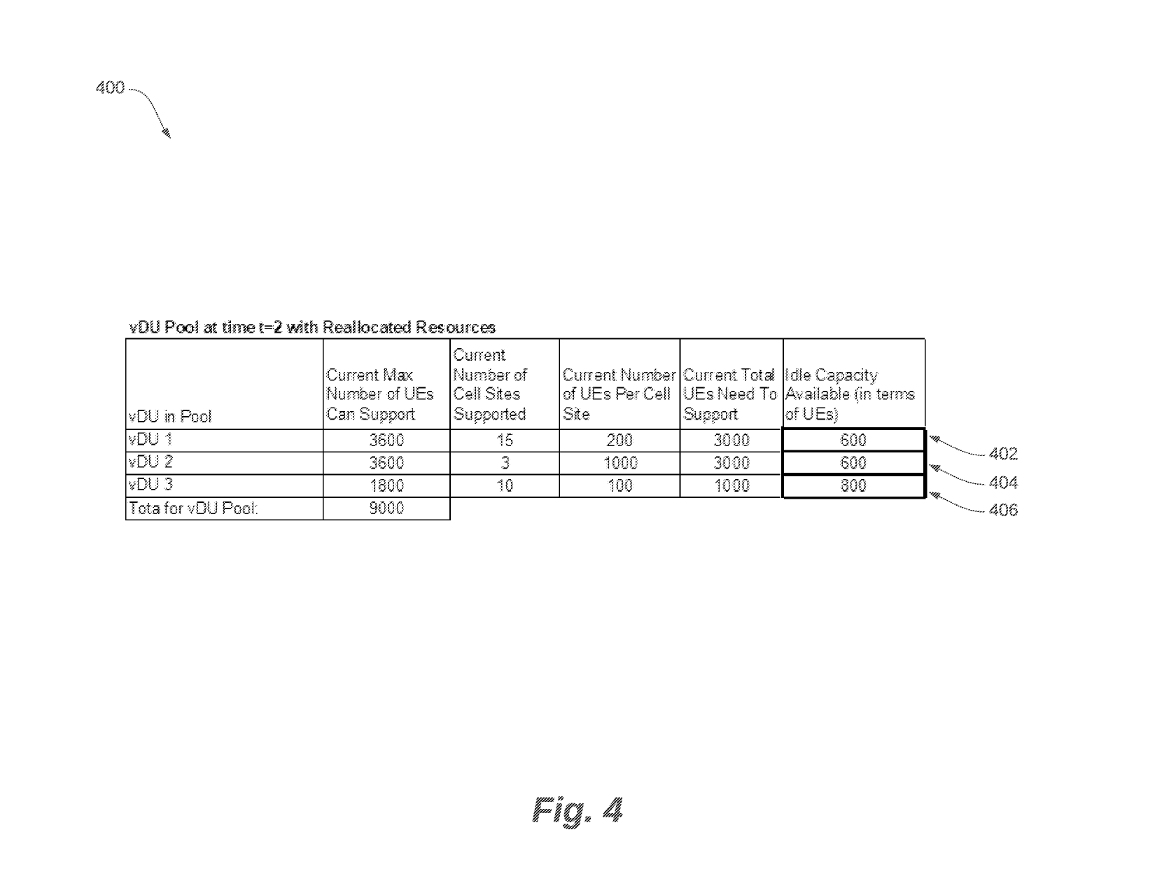

The system 200 enables efficient resource utilization and flexibility in allocating processing power to different cell sites, such as cell site 1104, cell site 2106, and cell site n 108, based on their current needs. For example, during peak hours in a business district, more resources can be allocated to cell sites in that area, while during off-hours, those resources can be reallocated to residential areas experiencing higher traffic. One example of resource reallocation appears in the FIG. 3 and FIG. 4.

FIG. 3 is a chart 300 illustrating an example of idle capacity of a vDU being detected in the ORAN vDU pool 102 by system 200, according to one non-limiting embodiment. The calculation tables in chart 300 are estimated and can vary based on deployment scenarios as well from vendor side in various different embodiments.

The chart 300 shows one example of how the system 200 can detect and track idle capacity of vDUs within the ORAN vDU pool 102. In the example shown, vDU 1 and vDU 2 are serving an increased demand at their respective cell sites with their current allocated resources, which brings them to their current maximum number of total UEs each can support. In particular, vDU 1 is currently serving 15 cell sites with a current number of UEs per cell site of 200 UEs, resulting in a total of 3000 UEs that vDU 1 needs to support. Also, vDU 2 is currently serving 3 cell sites with a current number of UEs per cell site of 1000 UEs, also resulting in a total of 3000 UEs that vDU 1 needs to support. This leaves no idle capacity for vDU 1 and vDU 2, as the current maximum number of UEs each vDU is able to support is 3000 UEs. However, system 200 has detected that vDU 3 has plenty of extra idle capacity, as the current number of cell sites it supports is 10 cell sites with 100 UEs per cell site, which results in a total of only 1000 UEs that vDU 3 needs to support and detected idle capacity available 302 for another 2000 UEs.

FIG. 4 is a chart 400 illustrating reallocation of the detected idle capacity 302 shown in the chart 300 of FIG. 3 to other vDUs in the ORAN vDU pool with higher traffic, according to one non-limiting embodiment. The calculation tables in chart 400 are estimated and can vary based on deployment scenarios as well from vendor side in various different embodiments.

The chart 400 shows how resources can be dynamically allocated within the ORAN vDU pool 102. In response to the system 200 detecting that vDU 3 has idle capacity available 302 for another 2000 UEs as shown in FIG. 3, the system 200 reallocates a substantial portion the idle processing capacity from vDU 3 to vDU 1 and vDU 2, providing vDU 1 and vDU 2 extra capacity to serve an additional 600 UEs each. This results in vDU 1 having an idle capacity available 402 to serve 600 additional UEs, vDU 2 having an idle capacity available 404 to serve 600 additional UEs and vDU 3 still having an idle capacity available 406 to serve 800 additional UEs. This reallocation allows vDU 1 and vDU 2 to handle the increased traffic demand without the need for additional hardware resources due to the shared physical server resources 202 shown in FIG. 2.

In various example embodiments, the system enables each vDU (e.g., vDU 1, vDU 2 and vDU 3) to dynamically adjust the number of UEs per cell site currently supported by the vDU up to the maximum number of UEs. This adjustment is based on the total number of cell sites supported by ORAN vDU pool 102 and current traffic demands at each cell site supported by ORAN vDU pool 102.

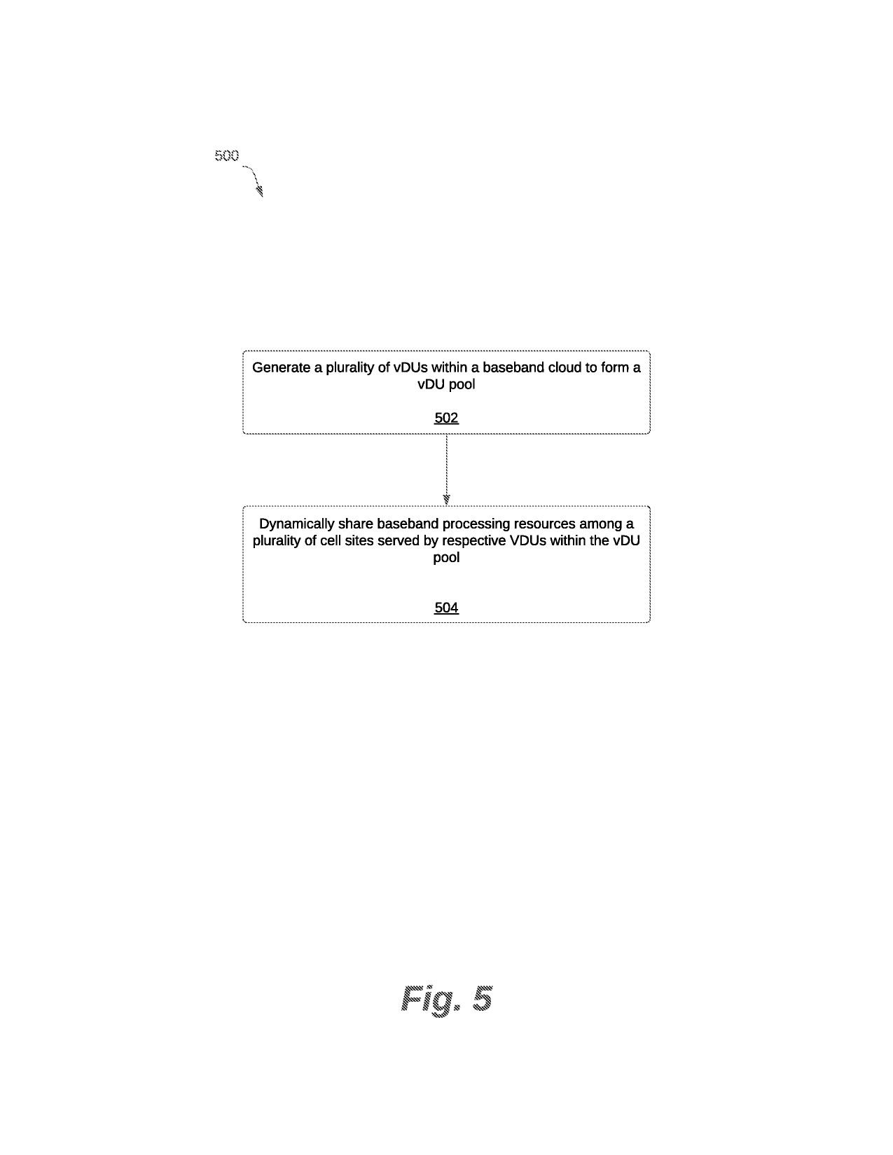

FIG. 5 is a flow diagram of an example method 500 in a system for DU pooling in wireless ORAN communication networks for utilizing additional capacity available in the ORAN vDU pool, according to one non-limiting embodiment.

At 502, the system generates a plurality of vDU instances vDUs within a baseband cloud to form an ORAN vDU pool. This involves creating virtual instances of Distributed Units that can be flexibly allocated and managed within the cloud infrastructure.

At 504, the system dynamically shares baseband processing resources among a plurality of cell sites served by respective vDUs within the ORAN vDU pool. This sharing is accomplished by reallocating idle processing capacities of vDUs within the pool serving underutilized cell sites to vDUs within the pool serving cell sites with higher traffic demands.

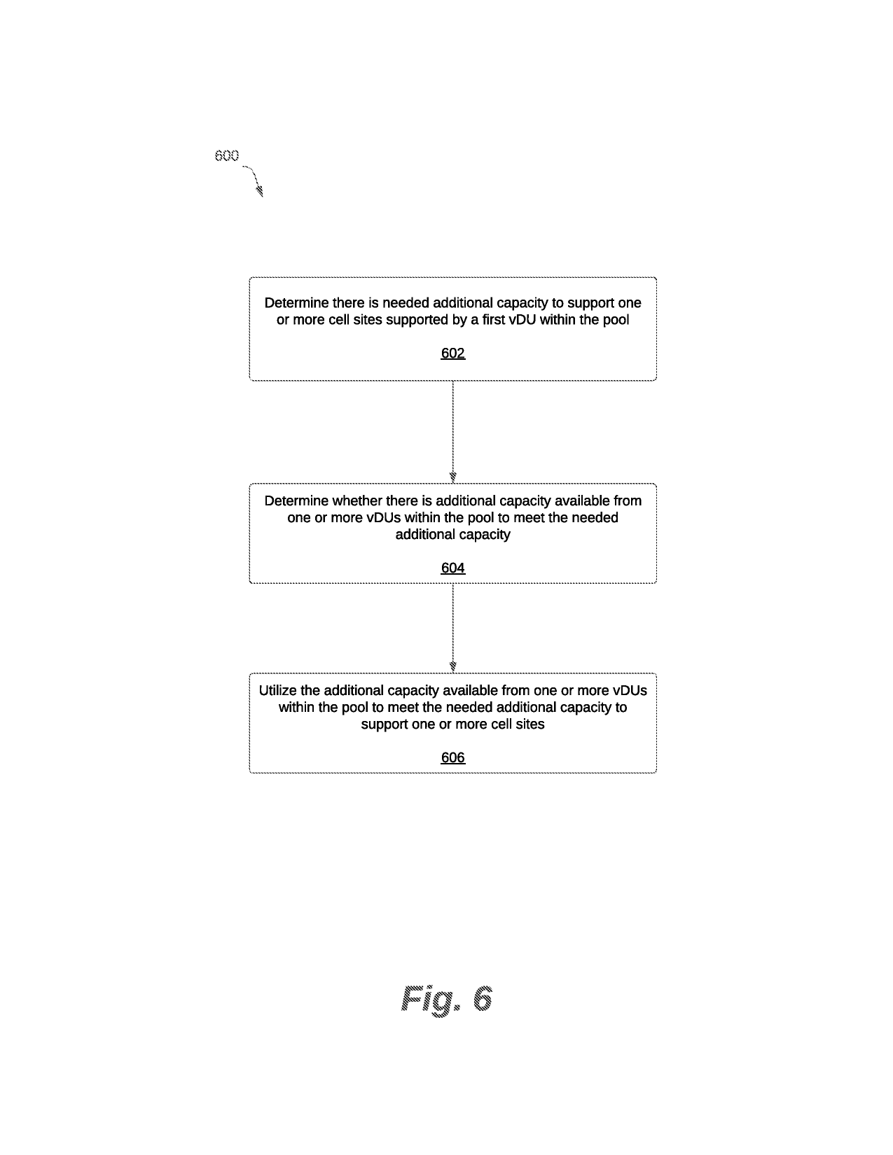

FIG. 6 is a flow diagram of an example method 600 in a system for DU pooling in wireless ORAN communication networks for utilizing additional capacity available in the ORAN vDU pool, according to one non-limiting embodiment.

At 602, the system determines there is needed additional capacity to support one or more cell sites supported by a first vDU within the pool. This determination may be based on monitoring traffic levels, resource utilization, or other relevant metrics.

At 604, in response to determining there is needed additional capacity, the system determines whether there is additional capacity available from one or more vDUs within the pool to meet the needed additional capacity. This involves assessing the current resource utilization of other vDUs in the pool to identify potential spare capacity.

At 606, in response to determining there is additional capacity available from one or more vDUs within the pool, the system utilizes the additional capacity available from one or more vDUs within the pool to meet the needed additional capacity to support one or more cell sites. This reallocation of resources allows the system to dynamically adapt to changing traffic demands across different cell sites. In an example embodiment, the plurality of vDUs share common physical server resources, enabling multiple Radio Access Network (RAN) services provided by the plurality of vDUs to run on the shared common physical server resources.

In various embodiments, each vDU of the plurality of vDUs is configured to support a predetermined maximum number of UEs. The system enables each vDU to dynamically adjust the number of UEs per cell site currently supported by the vDU up to the maximum number of UEs. This adjustment is based on the total number of cell sites supported by the ORAN vDU pool and current traffic demands at each cell site supported by the ORAN vDU pool.

The reallocation of idle processing capacities may include utilizing spare capacity of one vDU within the pool to support another cell site with higher traffic supported by another vDU within the pool. This technique enables efficient use of resources across the entire network. Resource pooling within the ORAN vDU pool enables logical resources used by the plurality of cell sites to be shared in the resource pool. This sharing of logical resources provides flexibility in resource allocation and improves overall system efficiency. In some embodiments, at least one vDU within the pool supports multiple cell sites, as illustrated in FIG. 3 and FIG. 4, further enhancing the flexibility and efficiency of the network.

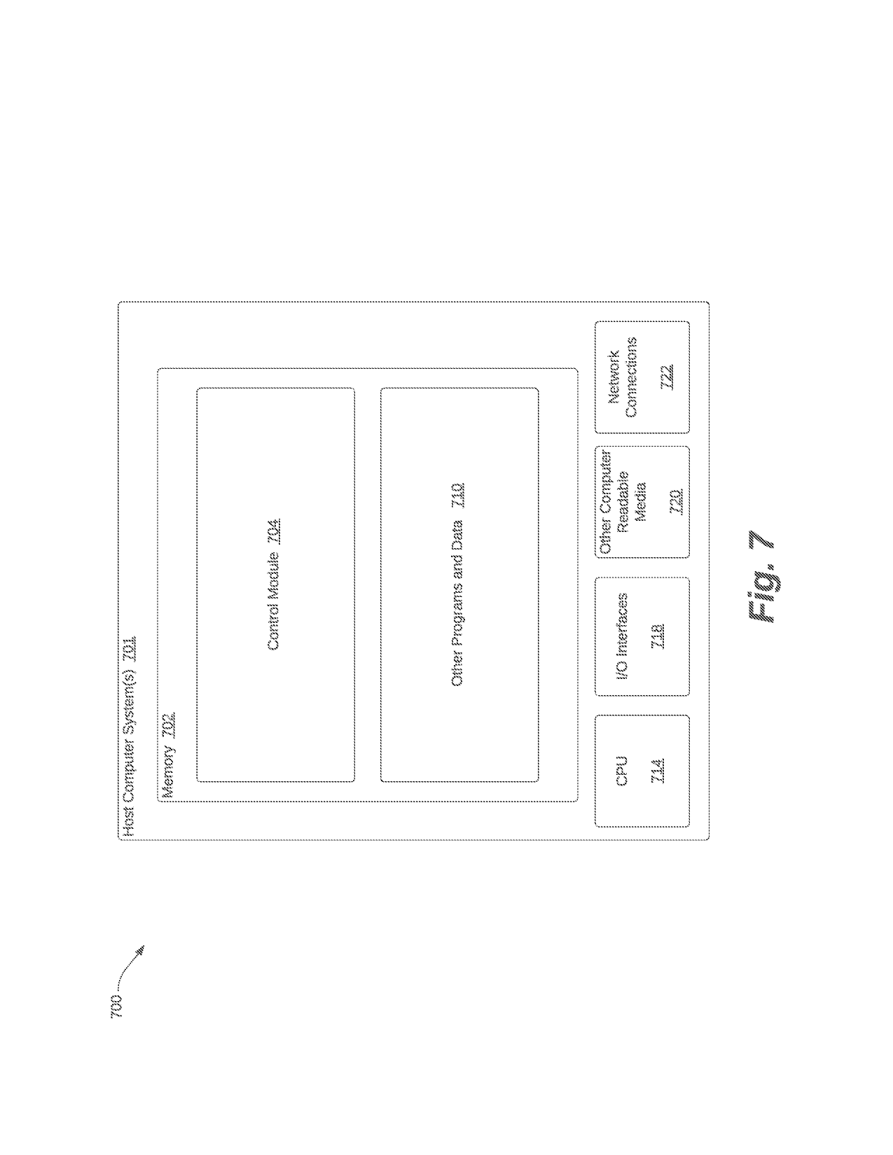

FIG. 7 shows a system diagram that describes an example implementation of an underlying computing system 700 for implementing embodiments described herein.

The functionality described herein for DU pooling in ORAN wireless telecommunication networks can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility. However, FIG. 7 illustrates an example of underlying hardware on which such software and functionality may be hosted and/or implemented.

In particular, shown is example host computer system(s) 701. For example, such computer system(s) 701 may represent one or more of those in various data centers, servers, network nodes, base stations and cell sites shown and/or described herein that are, or that host or implement the functions of: routers, components, microservices, PODs, containers, nodes, node groups, control planes, clusters, virtual machines, network functions (NFs), and/or other aspects described herein for DU pooling in ORAN wireless telecommunication networks. In some embodiments, one or more special-purpose computing systems may be used to implement the functionality described herein. Accordingly, various embodiments described herein may be implemented in software, hardware, firmware, or in some combination thereof. Host computer system(s) 701 may include memory 702, one or more processors such as central processing units (CPUs) 714, I/O interfaces 718, other computer-readable media 720, and network connections 722.

Memory 702 may be coupled to CPUs 714 and include one or more various types of non-volatile and/or volatile storage technologies. Examples of memory 702 may include, but are not limited to, flash memory, hard disk drives, optical drives, solid-state drives, various types of random access memory (RAM), various types of read-only memory (ROM), neural networks, other computer-readable storage media (also referred to as processor-readable storage media and non-transitory computer-readable storage media), or the like, or any combination thereof. Memory 702 may be utilized to store information, including computer-readable and computer-executable instructions that are utilized and executed by CPU 714 to cause operations to be performed, including those of embodiments described herein.

Memory 702 may have stored thereon control module(s) 704. The control module(s) 704 may be configured to implement and/or perform some or all of the functions of the systems, components and modules described herein for DU pooling in ORAN wireless telecommunication networks. Memory 702 may also store other programs and data 710, which may include rules, databases, application programming interfaces (APIs), rules and data, software containers, nodes, PODs, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 722 are configured to communicate with other computing devices to facilitate the functionality described herein. In various embodiments, the network connections 722 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 718 may include location data interfaces, sensor data interfaces, interfaces, other data input or output interfaces, or the like. Other computer-readable media 720 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for Distributed Unit (DU) pooling in wireless telecommunication networks, the method comprising:
generating a plurality of virtualized DU instances (vDUs) within a baseband cloud to form a vDU pool; and
dynamically sharing baseband processing resources among a plurality of cell sites served by respective vDUs within the vDU pool by reallocating idle processing capacities of vDUs within the pool serving underutilized cell sites to vDUs within the pool serving cell sites with higher traffic demands.

2. The method of claim 1, wherein the vDU pool is a vDU pool implemented within an Open Radio Access Network (ORAN) and the dynamically sharing includes:
determining there is needed additional capacity to support one or more cell sites supported by a first vDU within the pool;
in response to determining there is needed additional capacity, determining whether there is additional capacity available from one or more vDUs within the pool to meet the needed additional capacity; and
in response to determining there is additional capacity available from one or more vDUs within the pool, utilizing the additional capacity available from one or more vDUs within the pool to meet the needed additional capacity to support one or more cell sites.

3. The method of claim 1, wherein the plurality of vDUs share common physical server resources, enabling multiple Radio Access Network (RAN) services provided by the plurality of vDUs to run on the shared common physical server resources.

4. The method of claim 1, further comprising:
configuring each vDU of the plurality of vDUs to support a predetermined maximum number of User Equipment (UEs); and
enabling each vDU of the plurality of vDUs to dynamically adjust a number of UEs per cell site currently supported by the vDU up to the maximum number of UEs based on a total number of cell sites supported by the vDU pool and current traffic demands at each cell site supported by the vDU pool.

5. The method of claim 1, wherein the reallocation of idle processing capacities includes utilizing spare capacity of one vDU within the pool to support another cell site with higher traffic supported by another vDU within the pool.

6. The method of claim 1, wherein resource pooling within the vDU pool enables logical resources used by the plurality of cell sites to be shared in vDU pool.

7. The method of claim 1, wherein at least one vDU within the pool supports multiple cell sites.

8. A system for Distributed Unit (DU) pooling in wireless telecommunication networks, the system comprising:
at least one processor; and
at least one memory coupled to the at least one processor, wherein the at least one memory has computer-executable instructions stored thereon that, when executed by the at least one processor, cause the at least one processor to cause operations to be performed, the operations including:
generating a plurality of virtualized DU instances (vDUs) within a baseband cloud to form a vDU pool; and
dynamically sharing baseband processing resources among a plurality of cell sites served by respective vDUs within the vDU pool by reallocating idle processing capacities of vDUs within the pool serving underutilized cell sites to vDUs within the pool serving cell sites with higher traffic demands.

9. The system of claim 8, wherein the vDU pool is a vDU pool implemented within an Open Radio Access Network (ORAN) and the dynamically sharing includes:
determining there is needed additional capacity to support one or more cell sites supported by a first vDU within the pool;
in response to determining there is needed additional capacity, determining whether there is additional capacity available from one or more vDUs within the pool to meet the needed additional capacity; and
in response to determining there is additional capacity available from one or more vDUs within the pool, utilizing the additional capacity available from one or more vDUs within the pool to meet the needed additional capacity to support one or more cell sites.

10. The system of claim 8, wherein the plurality of vDUs share common physical server resources, enabling multiple Radio Access Network (RAN) services provided by the plurality of vDUs to run on the shared common physical server resources.

11. The system of claim 8, wherein the operations further include:
configuring each vDU of the plurality of vDUs to support a predetermined maximum number of User Equipment (UEs); and
enabling each vDU of the plurality of vDUs to dynamically adjust a number of UEs per cell site currently supported by the vDU up to the maximum number of UEs based on a total number of cell sites supported by the vDU pool and current traffic demands at each cell site supported by the vDU pool.

12. The system of claim 8, wherein the reallocation of idle processing capacities includes utilizing spare capacity of one vDU within the pool to support another cell site with higher traffic supported by another vDU within the pool.

13. The system of claim 8, wherein resource pooling within the vDU pool enables logical resources used by the plurality of cell sites to be shared in the vDU pool.

14. The system of claim 8, wherein at least one vDU within the pool supports multiple cell sites.

15. A non-transitory computer-readable storage medium having computer-executable instructions stored thereon that, when executed by at least one processor, cause operations to be performed, the operations including:
generating a plurality of virtualized Distributed Unit (DU) instances (vDUs) within a baseband cloud to form a vDU pool; and
dynamically sharing baseband processing resources among a plurality of cell sites served by respective vDUs within the vDU pool by reallocating idle processing capacities of vDUs within the pool serving underutilized cell sites to vDUs within the pool serving cell sites with higher traffic demands.

16. The non-transitory computer-readable storage medium of claim 15, wherein the vDU pool is a vDU pool implemented within an Open Radio Access Network (ORAN) and the dynamically sharing includes:
determining there is needed additional capacity to support one or more cell sites supported by a first vDU within the pool;
in response to determining there is needed additional capacity, determining whether there is additional capacity available from one or more vDUs within the pool to meet the needed additional capacity; and
in response to determining there is additional capacity available from one or more vDUs within the pool, utilizing the additional capacity available from one or more vDUs within the pool to meet the needed additional capacity to support one or more cell sites.

17. The non-transitory computer-readable storage medium of claim 15, wherein the plurality of vDUs share common physical server resources, enabling multiple Radio Access Network (RAN) services provided by the plurality of vDUs to run on the shared common physical server resources.

18. The non-transitory computer-readable storage medium of claim 15, wherein the operations further include:
configuring each vDU of the plurality of vDUs to support a predetermined maximum number of User Equipment (UEs); and
enabling each vDU of the plurality of vDUs to dynamically adjust a number of UEs per cell site currently supported by the vDU up to the maximum number of UEs based on a total number of cell sites supported by the vDU pool and current traffic demands at each cell site supported by the vDU pool.

19. The non-transitory computer-readable storage medium of claim 15, wherein the reallocation of idle processing capacities includes utilizing spare capacity of one vDU within the pool to support another cell site with higher traffic supported by another vDU within the pool.

20. The non-transitory computer-readable storage medium of claim 15, wherein resource pooling within the vDU pool enables logical resources used by the plurality of cell sites to be shared in the vDU pool.
